(19) United States
(12) Patent Application Publication
(10) Pub. No.: US 2007/0236035 A1
(43) Pub. Date: Oct. 11, 2007

(54) Truck Bed Extender/Midgate Storage System

(76) Inventor: Miguel WALDNER, Troy, MI (US)

Correspondence Address: MAGNA INTERNATIONAL, INC., 337 MAGNA DRIVE, AURORA, ON, L4G-7K1, US

(21) Appl. No.: 11/696,915

(22) Filed: Apr. 5, 2007

Related U.S. Application Data
(60) Provisional application No. 60/790,509, filed on Apr. 7, 2006.

(51) Int. Cl. B62D 33/08

(52) U.S. Cl. 296/26.11; 296/57.1

(57) ABSTRACT

A bed extender, having a base frame made of a hollow portion, a first open end, and a second open end. The bed extender also includes a first extending frame received by the first open end of the base frame, and a second extending frame received by the second open end of the base frame. The first extending frame and the second extending frame can either extend or retract into the hollow portion of the base frame, and when the first extending frame and the second extending frame are in an extended position, the bed extender will divide the bed of a pickup into two sections, or extend the overall length of the pickup bed.

### CROSS REFERENCE TO RELATED APPLICATIONS

This application claims the benefit of U.S. Provisional Application No. 60/790,509, filed Apr. 7, 2006. The disclosure of the above application is incorporated herein by reference.

### FIELD OF THE INVENTION

The present invention relates to a bed extender for maximizing the space available in the vehicle storage compartment.

### BACKGROUND OF THE INVENTION

Most vehicles provide some form of storage space or compartment. Automobiles that are in the car category usually have a storage compartment in the form of a trunk, while other larger vehicles such as pick-up trucks have a bed that can be used for storage. Additionally, semi-trucks have tractor trailers that provide a large enclosed trailer for storage of items. It is desirable to develop items that will maximize the storage space by allowing the space that's available to be sub-divided. For example it is sometimes desirable to divide a storage compartment into sections in order to provide spaces for the storage of various items. Additionally it is also desirable in the case of pick-up trucks and other vehicles having a storage bed to have a way of extending the sides of the bed in instances where oversized items need to be transported.

### SUMMARY OF THE INVENTION

The present invention is directed to a bed extender, having a base frame made of a hollow portion, a first open end, and a second open end. The bed extender also includes a first extending frame received by the first open end of the base frame, and a second extending frame received by the second open end of the base frame. The first extending frame and the second extending frame can either extend or retract into the hollow portion of the base frame, and when the first extending frame and the second extending frame are in an extended position, the bed extender will divide the bed of a pickup into two sections, or extend the overall length of the pickup bed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is an isometric view of a bed extender;

FIG. 1B is an isometric view of a track used to position the bed extender in a pickup bed when the bed extender is used to divide the pickup bed into sections;

FIG. 2 is a second isometric view of a bed extender used to divide the pickup bed into sections;

FIG. 3A is an enlarged isometric view of one side of a bed extender;

FIG. 3B is a second enlarged isometric view of one side of a bed extender;

FIG. 4 is a front perspective view of a bed extender;

FIG. 5 is an enlarged perspective view of a right extending frame and latch;

FIG. 6 is an isometric view of a bed extender, when the bed extender is configured to extend the overall length of a pickup bed;

FIG. 7 is a second isometric view of a bed extender when the side frames of the bed extender are extended and pivoting about the base frame;

FIGS. 8A-8C are schematic cross-sectional plan views of the tailgate and hooks of the base frame;

FIG. 9A is a side plan view of a driving wheel used with a second type of track used to position the bed extender in a pickup bed; and

FIG. 9B is an isometric view of the second type of track.

### DETAILED DESCRIPTION OF THE PREFERRED EMBODIMENTS

The following description of the preferred embodiment(s) is merely exemplary in nature and is in no way intended to limit the invention, its application, or uses.

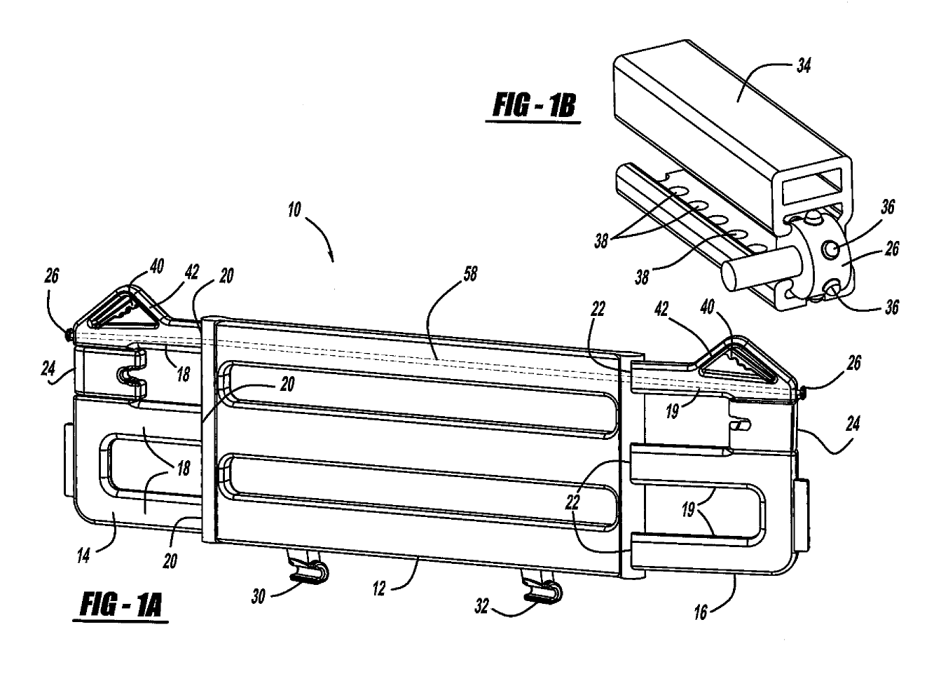

Referring to all the Figures and in particular FIG. 1A, a bed extender according to the present invention at 10. The bed extender 10 includes a base frame 12, a first extending frame 14, and a second extending frame 16. The base frame 12 is hollow and is accessible through a first set of openings 20 and a second set of openings 22. The first set of openings 20 receive the first set of rails 18 of the first extending frame 14, and the second set of openings 22 receive the second set of rails 19 of the second extending frame 16. The first extending frame 14 and second extending frame 16 are able to extend out of the first set of openings 20 and the second set of openings 22 respectively, or retract into the base frame 12.

The base frame 12, first extending member 14, and the second extending frame 16 are made of a composite plastic in this particular embodiment. However, it is also within the scope of the invention to manufacture the base frame 12, first extending frame 14, and second extending frame 16 of different materials such as steel or aluminum (depending on the particular application) without departing from the scope of the invention. Additionally, the base frame 12, first extending frame 14, and the second extending frame 16 may consist of a single piece of molded composite plastic, or multiple pieces assembled together.

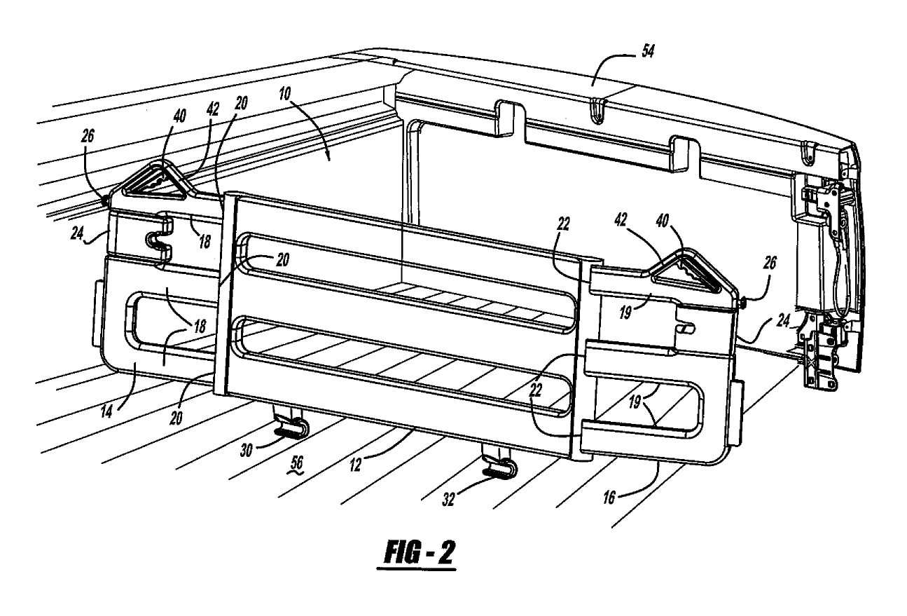

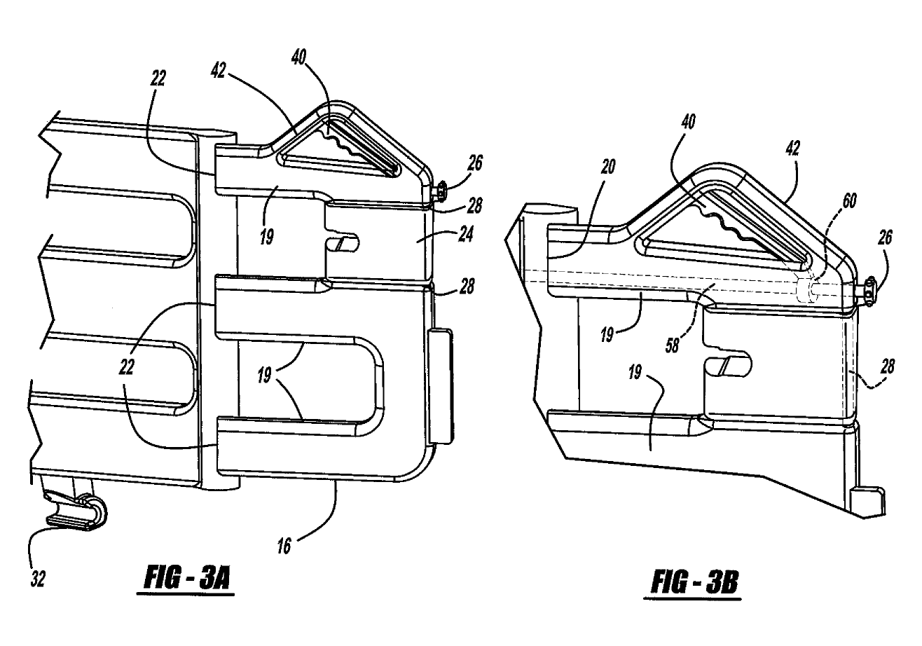

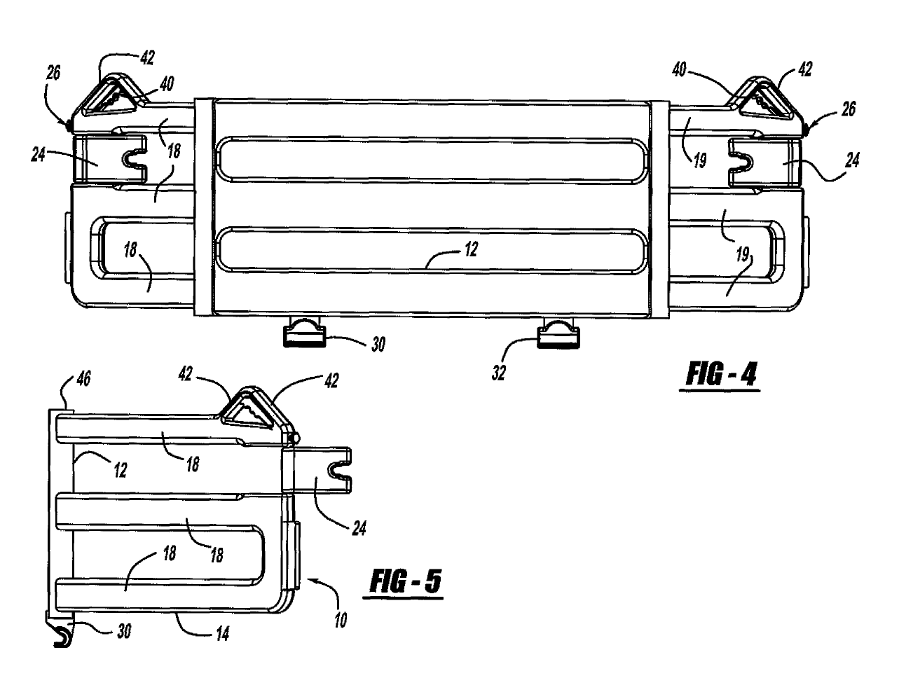

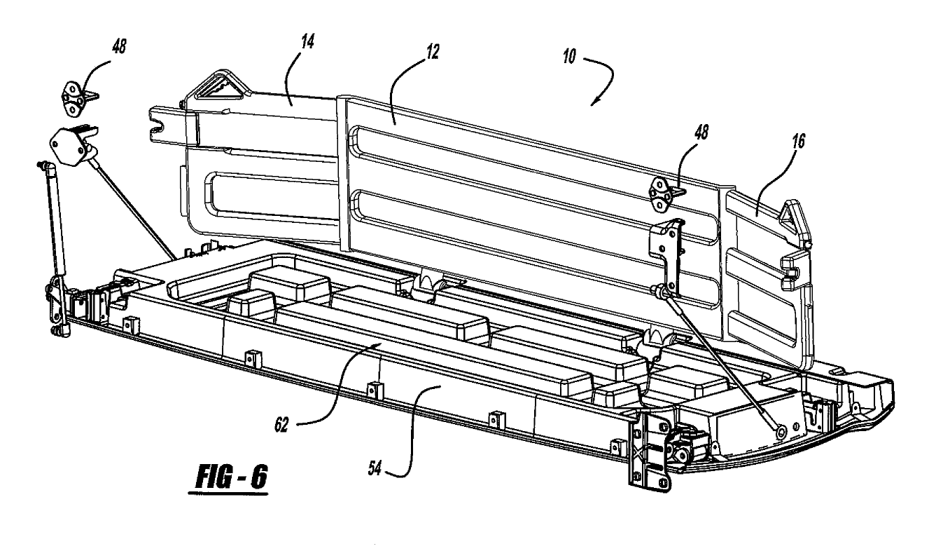

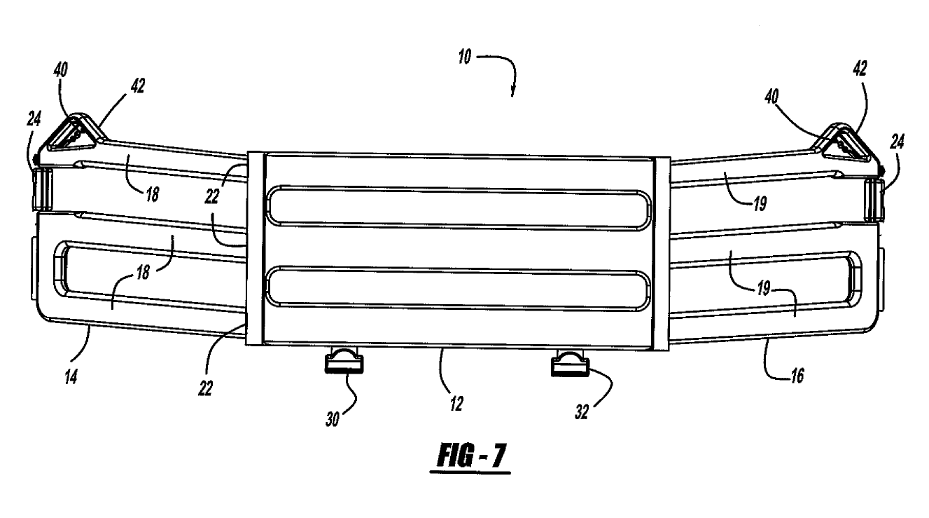

In one embodiment depicted in FIG. 2, the bed extender 10 is used to sub-divide the bed 56 into two or more sections. The driving wheels 26 are rotatably connected to both the first extending frame 14 and the second extending frame 16. The driving wheels 26 are used with a track 34, for adjusting the position of the bed extender in the bed of a pickup truck. The track 34 extends the length of the bed 56 and is connected to the top portion of both sides of the bed 56, and the driving wheels 26 can traverse the entire length of the track 34. However, the length of the track 34 can be set to any desired length, depending on how the bed extender 10 is to be used, and how the pickup bed is to be divided. It is within the scope of the invention to have the track 34 set to various lengths to accommodate various uses. Additionally, it is possible to have only one track with another type of lock mechanism on the other side of the bed extender 10 to hold the bed extender in place at a desired location.

The base frame 12 also includes a first hook mechanism 30, and a second hook mechanism 32, which are suited for connecting the bed extender 10 to a cross member 50 of the tailgate 54. Cross-members 50 are placed with a recess 52 formed in the tailgate 54. The hooks 30, 32 slide into the recess and grasp the cross members 50. This releasably holds the bed extender 10 to the tailgate 54 when in the stowed position. The bed extender 10 is removed from the tailgate 54 by rotating the bed extender 10 to an angle past ninety degrees until the hooks 30, 32 can lift away from the cross members 50.

The bed extender 10 of the present invention can be used in a number of ways. One way is to divide the bed of a pickup truck into two sections. The driving wheel 26 on the first extending frame 14 and the second extending frame 16 are synchronized such that they spin in unison when rotating along the track 34; this allows the bed extender 10 to remain perpendicular with the sides of a pick bed to create square or rectangular storage spaces.

Synchronization can be accomplished using a synchronizer mechanism such as a cable 58 or expandable, flexible rod that extends across the inside of the bed extender 10 and is connected to the driving wheel 26. The synchronizer mechanism controls the rotation of the driving wheels 26 to ensure that they all rotate in unison. This prevents the bed extender 10 from jamming in the tracks 34. In one particular embodiment of the invention depicted in FIG. 1B, each driving wheel 26 has splines 36 which are inserted in the holes 38 of the track 34. In FIGS. 10A and 10B, the driving wheel 26 is the same, but the track 34 has a C-channel 44 instead of the holes 38 shown in FIG. 1B. In all embodiments the tracks 34 are made out of extruded aluminum or they can be made from other metals or polymeric materials. The bed extender 10 can be used for pickup beds of varying widths as well. The track 34 is simply mounted to the bed of a pickup, and the first extending frame 14 and second extending frame 16 are extended out of the base frame 12 to allow each driving wheel 26 to fit into track 34. The first extending frame 14 and the second extending frame 16 each have a trigger mechanism 40, and a handle 42 that are used to control a brake mechanism that is operably connected to the cable 58. The trigger mechanism 40 must be depressed into the handle 42. The brake mechanism 60 allows the rotatable wheels 26 to rotate. When the trigger mechanism 40 is released, the brake mechanism 60 locks the cable 58 and prevents the wheels 26 from rotating.

Another function of the bed extender 10 is to increase the overall length of a bed. When the bed extender 10 is used in this fashion, the first hook mechanism 30 and second hook mechanism 32 attach the base frame 12 of a striker 48 on a bed 58. When a tailgate 54 is fully opened, the bed extender 10 is positioned perpendicular to the bottom of the pickup bed, and the first extending frame 14 and second extending frame 16 are fully extended away from the base frame 12. When fully extended, the first extending frame 14 and second extending frame 16 can swing about a pivot point 46. This allows the extending frames 14, 16 to connect to the bed 56 through the use of the latch 24. The latch 24 connects the striker 46 of a bed 56. In this position, the bed extender 10 increases the overall storage capacity of a bed 56.

When not in use, the first extending frame 14 and the second extending frame 16 are retracted into the base frame 12. The first hook mechanism 30 and the second hook mechanism 32 are connected to the cross-member of the tailgate 54. The bed extender 10 is rotated about the cross-member and will rest against the tailgate in a holder 62. The tailgate 54 is then closed, stowing the bed extender 10. The first hook mechanism 30 and the second hook mechanism 32 along with the cross-member act as a pivot point for the bed extender 10. Rotating the bed extender 10 beyond a perpendicular position relative to the tailgate thirty or forty degrees more allows the bed extender 10 to be completely removed from the bed 56, or to be used to divide the bed 56 into sections, as previously described.

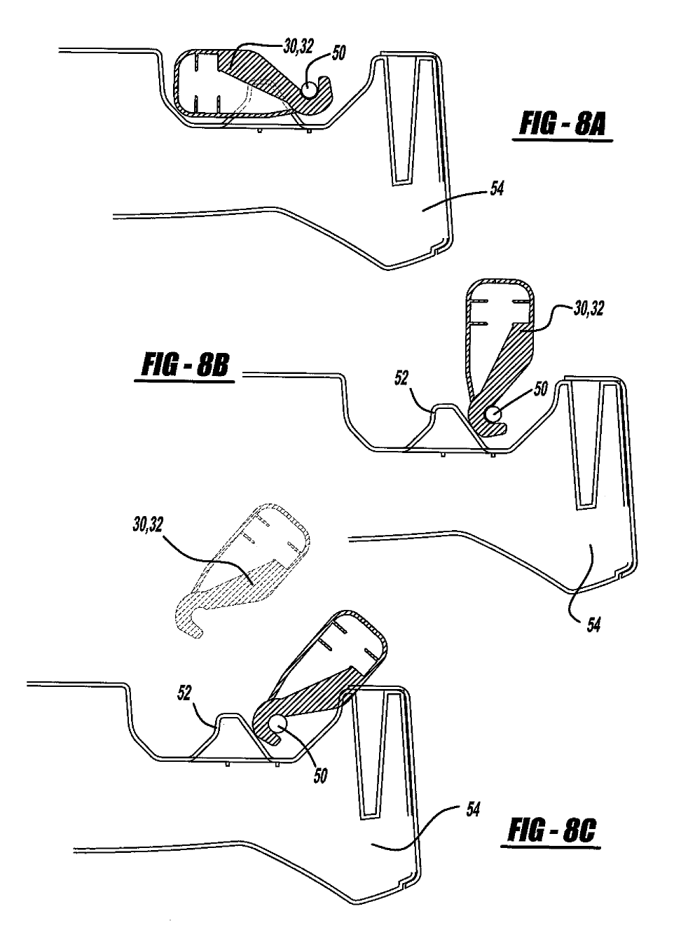

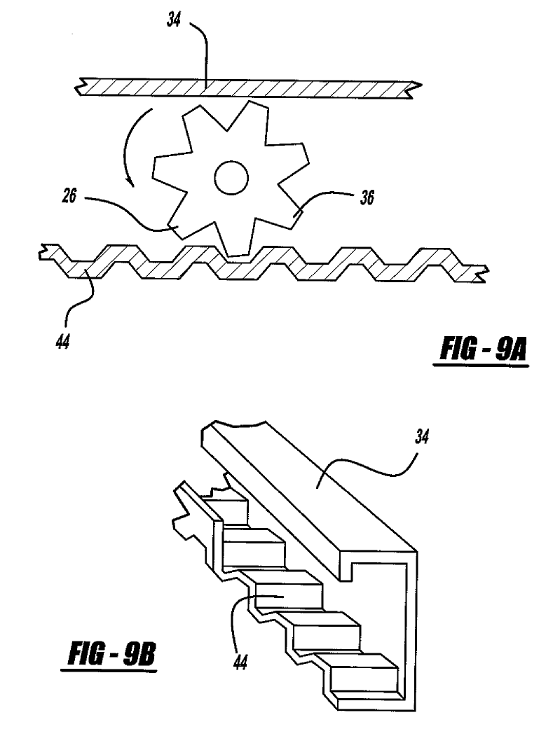

Referring to FIGS. 8a-8c the interaction of the hooks 30, 32 with a cross-member 50 is shown. A tailgate 54 has a recess 52 and cross member 50. The first and second hooks 30, 32 rotatably clasp onto and are positioned between the tailgate 54 and a cross-member 50 when the bed extender is in the stowed position. If the bed extender 10 is going to be used to extend the surface of a vehicle bed then the bed extender 10 is detached from the tailgate 54 by rotating the first and second hooks 30, 32 to an approximately ninety degree angle until the hooks 30, 32 are clear from the recess 52 and can be pulled away from the cross member 50

Additionally, the first hook mechanism 30 and the second hook mechanism 32 can also be used to reposition the bed extender 10 at different positions along a pickup bed having cross-members placed at various predetermined positions on the pickup bed. This configuration can be used in place of having track 34. The bed extender 10 is repositioned along these various cross-members in the same manner as just described, but the bed extender 10 is used to divide the pickup bed into two sections, instead of extending the overall length of the pickup bed. Using the bed extender 10 in this manner allows for the bed extender 10 to divide the pickup bed into sections without using the driving wheel 26 and track 34.

While the present embodiment discloses the bed extender 10 having three segments, a base frame 12, a first extending frame 14, and a second extending frame 16, it is within the scope of the invention that the bed extender 10 may include any number of frames to suit a particular application.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A bed extender, comprising:
a base frame having a hollow portion;
a first extending frame configured to slide into said hollow portion of said base frame; and
a second extending frame configured to slide into said hollow portion of said base frame, wherein when said first extending frame and said second extending frame are in an extended position, said bed extender can be used to divide a bed into two sections, or extend the overall length of said bed.

2. The bed extender of claim 1, wherein said first extending frame and said second extending frame have a latch which connects said first extending frame and said second extending frame to a striker of a vehicle when said bed extender is used to extend the length of said bed.

3. The bed extender of claim 1, wherein when said first extending frame is fully extended from said base frame, said first extending frame will pivot about said base frame.

4. The bed extender of claim 3, wherein when said second extending frame is fully extended from said base frame, said second extending frame will pivot about said base frame.

5. The bed extender of claim 1, further comprising at least one driving wheel connected to said first extending frame and at least one driving wheel connected to said second extending frame, and a bed which includes a track for receiving said driving wheel of said first extending frame and said second extending frame, wherein said driving wheel of said first extending frame and said driving wheel of said second extending frame operate to reposition said bed extender along said track of said bed.

6. A bed extender, comprising:
a base frame having a hollow portion;
a first extending frame configured to slide into said hollow portion of said base frame, wherein said first extending frame is pivotable with respect to said base frame;
a second extending frame configured to slide into said hollow portion of said base frame, wherein said second extending frame is pivotable with respect to said base frame;
one or more rotatable wheels connected to each said first extending frame and said second extending frame, wherein said one or more rotatable wheels are used to connected said bed extender to a vehicle.

7. The bed extender of claim 6 further comprising one or more tracks for receiving said one or more rotatable wheels, wherein said one or more rotatable wheels are configured to rotate in said one or more tracks for sliding said bed extender along said one or more tracks.

8. The bed extender of claim 7 wherein said one or more tracks are C-channels and said one or more rotatable wheels each have one or more splines configured to be received in said C-channels as said one or more rotatable wheels rotate in said one or more tracks.

9. The bed extender of claim 7 further comprising a plurality of holes formed in the surface of said one or more tracks and a plurality of splines formed on said one or more rotatable wheels, wherein at least one of said plurality of splines engage at least one of said plurality of holes during the rotation of said one or more rotatable wheels in said one or more tracks.

10. The bed extender of claim 6 further comprising a synchronizer mechanism connectable to all of said one or more rotatable wheels for synchronizing the rotation of all of said one or more rotatable wheels.

11. The bed extender of claim 10 wherein said synchronizer mechanism is a cable rotatable connected to all of said one or more rotatable wheels.

12. The bed extender of claim 10 further comprising a handle and trigger mechanism on each said first and second extending frames, wherein said triggering mechanism is operably connected to said synchronizer device or said one or more rotatable wheels to brake the rotation of the said one or more rotatable wheels.

13. The bed extender of claim 6, wherein said first extending frame and said second extending frame have a latch which connects said first extending frame and said second extending frame to a striker of a vehicle.

14. A bed extender, comprising:
a base frame having a hollow portion;
a first extending frame received by said hollow portion of said base frame;
a second extending frame received by said hollow portion of said base frame; and
one or more hook mechanisms connected to said base frame for connecting said bed extender to a cross member of a vehicle.

15. The bed extender of claim 14 further comprising:
one or more holding features and one or more bars on a molded recess formed in said vehicle, wherein said one or more hooks slide past said one or more holding features and grasp said one or more bars to secure said bed extender to said vehicle.

16. The bed extender of claim 14, wherein said first extending frame and said second extending frame have a latch which connects said first extending frame and said second extending frame to a striker of a vehicle.

17. The bed extender of claim 14, wherein when said first extending frame is fully extended from said base frame, said first extending frame will pivot about said base frame.

18. The bed extender of claim 17, wherein when said second extending frame is fully extended from said base frame, said second extending frame will pivot about said base frame.

19. The bed extender of claim 17, further comprising at least one driving wheel connected to said first extending frame and at least one driving wheel connected to said second extending frame, and a pickup bed which includes a track for receiving said driving wheel of said first extending frame and said second extending frame, wherein said driving wheel of said first extending frame and said driving wheel of said second extending frame operate to reposition said bed extender along said track of said pickup bed.

20. The bed extender of claim 19 further comprising a synchronizer mechanism connectable to all of said one or more rotatable wheels for synchronizing the rotation of all of said one or more rotatable wheels.
